(19) United States
(12) Patent Application Publication
(10) Pub. No.: US 2021/0389752 A1
(43) Pub. Date: Dec. 16, 2021

(54) WHEELED MILITARY LAND VEHICLES ASSEMBLY/DISASSEMBLY PLC SYSTEM

(71) Applicant: FNSS SAVUNMA SÍSTEMLERÍ A.S., GÖLBASI (TR)

(72) Inventors: RAMAZAN KULAÇOGLU, GÖLBASI (TR); FATÍH ÜLGER, GÖLBASI (TR); MUSTAFA YURDAKUL, GÖLBASI (TR)

(21) Appl. No.: 17/276,203

(22) PCT Filed: Aug. 19, 2020
(86) PCT No.: PCT/TR2020/050725

§ 371 Date: Mar. 15, 2021

(30) Foreign Application Priority Data
Sep. 25, 2019 (TR) 2019/14589

(51) Int. Cl. G05B 19/4155; B62D 65/02

(52) U.S. Cl. CPC G05B 19/4155; B62D 65/10; B62D 65/022

(57) ABSTRACT

The invention relates to the PLC system (400) providing automatic assembly/disassembly of the vehicle subsystems such as wheel, suspension, axle complex, power transfer etc. of the military land vehicles. In particular, the invention relates to the PLC system (400) having its own database that controls all moving elements and safety systems within the automation system and having a programmable structure.

### TECHNICAL FIELD

The invention relates to the PLC system providing automatic assembly/disassembly of the vehicle subsystems such as wheel, suspension, axle complex, power transfer etc. of the military land vehicles. In particular, the invention relates to the PLC system (400) having its own database that controls all moving elements and safety systems within the automation system and having a programmable structure.

### THE STATE OF THE ART

In parallel to the technological development, the great development in the military systems is also experienced. The main purposes of these developments are desire to make the military vehicle fast, comfortable, useful and safe. Therefore, the foremost among these military technologies, which are popular in recent years, is the military land vehicle technologies. It is continued to make necessary developments to accelerate the production during the assembly of these vehicles.

In the present art, the assembly/disassembly of the subsystems on vehicles is performed mostly based on manual manpower by using the hydraulic scissor platform carrying the load stands in standard size having no height control and the work pieces only with the manual guide.

Mobility of standard-sized load stands, which do not have height control in the present art, is limited. This has a limiting effect on the vehicle assembly operations having variable body dimensions. The most disadvantage of these systems is that they are suitable for the serial production of the standard work pieces in stable sizes. When the length, shape and weight of the work piece change, the present system becomes functionless.

The standard assembly apparatus that are production line project based in the present art and used in the firms continuously spanning are not suitable for the structures such as axle complex having different sizes and weights, suspension systems, power transfer groups etc. This situation that does not provide flexible working opportunity affects the quality of the work negatively. It is hard to position these subsystems having different physical features to the vehicle; therefore, assembly problems are often experienced.

The methods used in the present art mostly consist of non-ergonomic, high labour force and time-consuming operation steps having a large number of operations based on manpower. Balancing and alignment problems not only affect the quality of the work, but also seriously affect work safety when considering tonnage work pieces.

The manpower-based manual systems used in the present art create a relatively unsafe working environment, and these non-ergonomic systems cause occupational disturbances over time. Also, the requirement of qualified personnel is in advanced stage in these conventional assembly processes. The quality of work depends directly on the competence and experience of the personnel. Another important problem of the techniques used in the present art is that positioning of the big parts (of the vehicle body) for the assembly by using cranes, chains, retainers and straps and aligning the heavy tonnage vehicle subsystems to the vehicle are always time-consuming and dangerous. Assembly/disassembly process in the workshop environment should rarely be in an optimum position for the most efficient use of the manpower or the equipment. Repeated positioning for the different work pieces may damage the production plans. Repeatability of positioning and alignment from assembly to assembly is almost impossible.

In conclusion, the need for a new economic, useful wheeled military land vehicle assembly/disassembly automation system and the inadequacy of the existing solutions have made an improvement necessary in the relevant technical field for the solution of the above-mentioned problems in the present technique.

### OBJECT OF THE INVENTION

The present invention relates to the automation systems providing the automatic assembly/disassembly of the heavy tonnage military vehicles having variable body structure (size and weight) developed to eliminate the above-mentioned disadvantages and to bring new advantages to the relevant technical field; the vehicle mobility systems such as suspension, axle complex, power transfer group etc. with the PLC (Programmable Logical Controller) compatible with the Industry 4.0 technology.

The main object of the invention is to provide the assembly/disassembly of all work pieces working project-based regardless of the geometrical shape, measure and weight of the work piece (vehicle body and subsystems) continuously change with respect to the production/assembly line needs.

Another object of the invention is to automatically balance the drive and slave tower and vehicle body with respect to the sizes, weight and center of gravity. Automatically controlled vehicle working synchronously with the towers and having freedom of movement in all directions with a subsystem installed on it also automatically reaches the most suitable position under the vehicle body for the assembly/disassembly with PLC control. With this feature, the system offers the possibility of simple, sensitive and quality assembly/disassembly. Also, the towers and automatic guided vehicle forming the system have a construction and movement system design that can safely carry the body and subsystems with heavy tonnage capacity and are robust and stable in accordance with the heavy industrial conditions.

Another object of the invention is to save time for the operation on the work piece by facilitating the detachment/attachment (assembly) steps on the work piece. As this system design increases the speed and efficiency, it minimizes the labour force (human) requirement and provides an important advantage in the production/assembly lines. With the system design that offers a fully ergonomic working environment, the worker health has been significantly protected. With this design, the need for additional qualified personnel for the assembly/disassembly has been eliminated. Therefore, the speed of assembly/disassembly operation has been increased with the automation system, and the risk of injury and work accident has been reduced by providing working environment in appropriate ergonomics. With the automatic guided vehicle, the assembly labour time has been significantly reduced.

Another object of the invention to stop the operation with the lock pins and emergency buttons in accordance with the settings in a controlled manner by the system warning the operator with audio and video stimulus in a situation contrary to work safety by means of the data reading elements (sensors, switches, field searchers) and programmable software connected to the PLC control. In this way, safety has been maximized and situations contrary to work safety have been prevented. Also, the PLC control unit instantly transmits the information about the status of the system within the assembly cell the screen on the control panel by evaluating the data coming from the sensors and switches. With this design, safety has been maximized and situations contrary to work safety have been prevented. Also, the PLC control unit instantly transmits the information about the status of the system within the assembly cell the screen on the control panel by evaluating the data coming from the sensors and switches.

Another object of the invention is to predefine the vehicle body and subsystem information (size, weight, mounting points, center of gravity, mounting coordinates etc.) to be pre-assembled/disassembled to the PLC system.

Another object of the invention is to provide flexible assembly having unlimited mobility within the system limits (area information, carrying capacity, vehicle and subsystem information) in which the automation system is predetermined in the design.

Another object of the invention is that the information recorded in the database of the PLC system has a flexible structure that can be changed, updated, added and removed at any time by means of the user interface and it can be improved. Therefore, it provides consistent repeatable quality process (assembly/disassembly) procedures for the same type of vehicle body as this system design; regardless of its geometric shape, size and weight, all work pieces can be assembled/disassembled. Another object of the invention is that the type of the work piece (suspension, axle assembly, power transfer, etc.) placed on the automatically guided vehicle automatically reaches the mounting coordinates under the mounting body of the automatic guided vehicle and the appropriate height (on the Z axis) by being selected from the PLC control panel.

Another object of the invention is to control the system automatically with the PLC control if desired, or manually with the remote control if desired. Even if it is controlled by the manual method, assembly/disassembly processes can be performed in safer and ergonomic way compared to the conventional systems.

Another object of the invention is to increase safety and efficiency by improving the production environment with the wireless communication system between the towers and the automatically guided vehicles. With the improved wireless communication method, cables and similar interfaces that restrict the movement among the elements forming the system have been eliminated and a more free and safe working environment have been provided.

Another object of the invention is that it has low maintenance cost.

The structural and characteristic features and all the advantages of the invention will be more clearly understood by means of the figures given below and the detailed description written with reference to these figures and therefore, the evaluation should be performed by taking these figures and detailed description into account.

### DRAWINGS ASSISTING THE UNDERSTANDING OF THE INVENTION

FIG. 1 is the illustration showing the assembly/disassembly PLC system of the wheeled military land vehicles according to the invention.

FIG. 2 is the illustration showing the assembly/disassembly PLC system of the wheeled military land vehicles with the work piece according to the invention.

FIG. 3 is the illustration showing the assembly/disassembly PLC system of the wheeled military land vehicles according to the invention.

FIG. 4 is the illustration showing the drive tower of the assembly/disassembly PLC automation system of the wheeled military land vehicles according to the invention.

FIG. 5 is the illustration showing the slave tower of the assembly/disassembly PLC automation system of the wheeled military land vehicles according to the invention.

FIG. 6 is the illustration showing the tower vertical movement system of the assembly/disassembly PLC automation systems of the wheeled military land vehicles according to the invention.

FIG. 7 is the illustration showing the tower ground locking system (Detail A) of the assembly/disassembly PLC system of the wheeled military land vehicles according to the invention.

FIG. 8 is the illustration showing the tower vertical movement system (Detail B) of the assembly/disassembly PLC system of the wheeled military land vehicles according to the invention.

FIG. 9 is the illustration showing the tower area scanning sensor (Detail C) of the assembly/disassembly PLC system of the wheeled military land vehicles according to the invention.

FIG. 10 is the illustration showing the tower existence absence sensor (Detail D) of the assembly/disassembly PLC system of the wheeled military land vehicles according to the invention.

FIG. 11 is the illustration showing the tower mounting apparatus lock switch (Detail E) of the assembly/disassembly PLC system of the wheeled military land vehicles according to the invention.

FIG. 12 is the illustration showing the tower horizontal movement system (Detail F) of the assembly/disassembly PLC system of the wheeled military land vehicles according to the invention.

FIG. 13 is the illustration showing the automatically guided vehicle of the assembly/disassembly PLC system of the wheeled military land vehicles according to the invention.

FIG. 14 is the illustration showing the area scanning sensor (Detail G) of the automatically guided vehicle according to the invention.

FIG. 15 is the illustration showing the automatically guided vehicle of the assembly/disassembly PLC system of the wheeled military land vehicles according to the invention.

FIG. 16 is the illustration showing the upper plate complex of the automatically guided vehicle according to the invention.

FIG. 17 is the illustration showing the automatically guided vehicle as disassembled according to the invention.

FIG. 18 is the illustration showing the scissor platform complex of the automatically guided vehicle according to the invention.

FIG. 19 is the illustration showing the scissor platform detail of the automatically guided vehicle according to the invention.

FIG. 20 is the illustration showing the scissor platform distance sensor (Detail H) of the automatically guided vehicle according to the invention.

FIG. 21 is the illustration showing the scissor platform bearing (Detail I) of the automatically guided vehicle according to the invention.

FIG. 22 is the illustration showing the upper car complex of the automatically guided vehicle according to the invention.

FIG. 23 is the illustration showing the horizontal movement system (Detail J) of the upper car complex of the automatically guided vehicle according to the invention.

FIG. 24 is the illustration showing the track rail slide (Detail K) of the upper car complex of the automatically guided vehicle according to the invention.

FIG. 25 is the illustration showing the rail car mechanisms (Detail L) of the upper car complex of the automatically guided vehicle according to the invention.

FIG. 26 is the illustration showing the track rail slide (Detail M) of the upper car complex of the automatically guided vehicle according to the invention.

FIG. 27 is the illustration showing the upper car centering pins (Detail N) of the automatically guided vehicle according to the invention.

FIG. 28 is the illustration showing the hydraulic unit (Detail O) of the upper car complex of the automatically guided vehicle according to the invention.

FIG. 29 is the illustration showing the hydraulic cylinders (Detail P) of the upper car of the automatically guided vehicle according to the invention.

FIG. 30 is the illustration showing the lower car complex of the automatically guided vehicle according to the invention.

FIG. 31 is the illustration showing the horizontal movement system (Detail R) of the lower car complex of the automatically guided vehicle.

REFERENCE NUMBERS

100. Drive Tower
110. Protective Blower
111. Body Mounting Apparatus
112. Lock pins
113. Vertical Movement System
113.1 Vertical Movement Motor
113.2 Reductor 1
113.3 Reductor 2
114. Tower ground Locking System
115. Locking Pin
116. Tower Lock Main Body
117. Horizontal Axis Safety Switch
119. Vertical Movement lock System
120. Ball Screw
121. Vertical Movement lock Body
122. Vertical Movement Lock Handle
123. Carrier Table
124. Vertical Rail
125. Vertical Movement Safety Switch
126. Screwed Bearing
127. Rail Slide
130. Tower Area Scanner Sensor
131. Existence Absence Sensor
132. Mounting Apparatus Lock switch
133. Tower Horizontal Movement System
134. Horizontal Movement Motor
135. Coupling
136. Gear System
137. Bearing
138. Wheel Shaft
139. Tower Wheel
140. Tower Warning System (Audio and Video)
150. Slave Tower
200. Tracking Rail
300. Control Panel
400. PLC System
500. Anchor Ray
510. Tower Stopper
600. Automatically guided Vehicle
601. Vehicle Control
602. Traction Battery
603. Warning System (Audio and Video)
604. Vehicle PLC System
605. Upper Plate Complex
606. Vehicle Area Scanner Sensor
607. Emergency Stop Button
608. Intentional Platform Complex
609. Upper Vehicle Complex
610. Lower Vehicle Complex
611. Work piece Carrying Plate
612. Work piece Positioning Pin
613. Hydraulic Jack
614. Upper Plate Centering Pin
615. Balls
616. Scissor Platform Upper Table
617. Plate Fixing Apparatus
618. Screwed Bearing
619. Scissor Structure
620. Scissor Structure Movement Motor
621. Scissor Platform Lower Table
622. Puller Shaft
623. Tongue
624. Puller Slot
625. Ball Bearing
626. Ball Screw
627. Coupling
628. Distance Sensor (Z Axis)
629. Blocking Shaft
630. Upper Car Body
631. Upper Car Movement System (X Axis)
632. Horizontal Movement Motor
633 Coupling
634. Gear System
635. Bearing
636. Wheel Shaft
637. Upper Car Wheel
638. Tracking Rail Bearing (X Axis)
639. Limit Shaft
640. Limit Sensor (X Axis)
641. Rail Car Mechanisms
642. Distance Sensor (Y Axis)
643. Limit Sensor (Y Axis)
644. Tracking Rail Bearings (Y Axis)
645. Centering Pins
646. Hydraulic Unit
647. Hydraulic Cylinders
648. Lower Car Body
649. Centering Columns
650. Pressure Plate
651. Lower Car Movement System (Y Axis)
652. Horizontal Movement Motor
653. Coupling
654. Gear System
655. Bearing
656. Wheel Shaft
657. Lower Car Wheel
700. Main Mounting Body
800. Work piece
900. Automation Cell

### DETAILED DESCRIPTION OF THE INVENTION

In this detailed description, preferred embodiments of the wheeled military land vehicle assembly/disassembly automation system are described only for a better understanding of the subject and without any limiting effects.

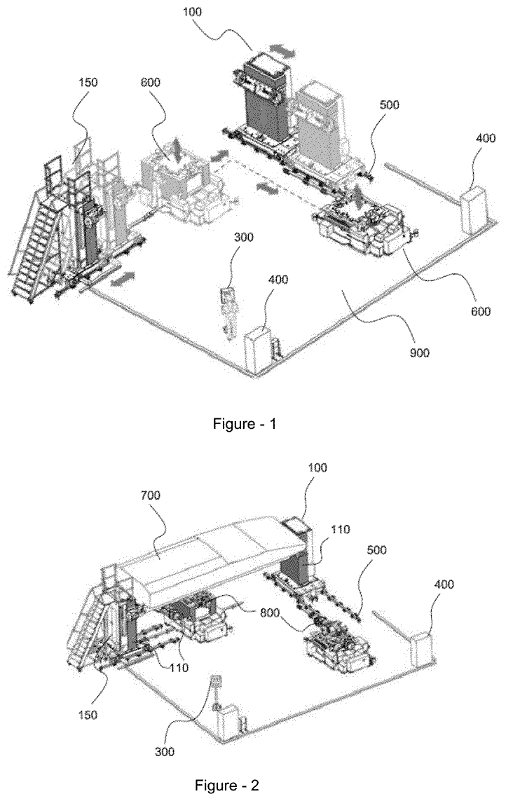

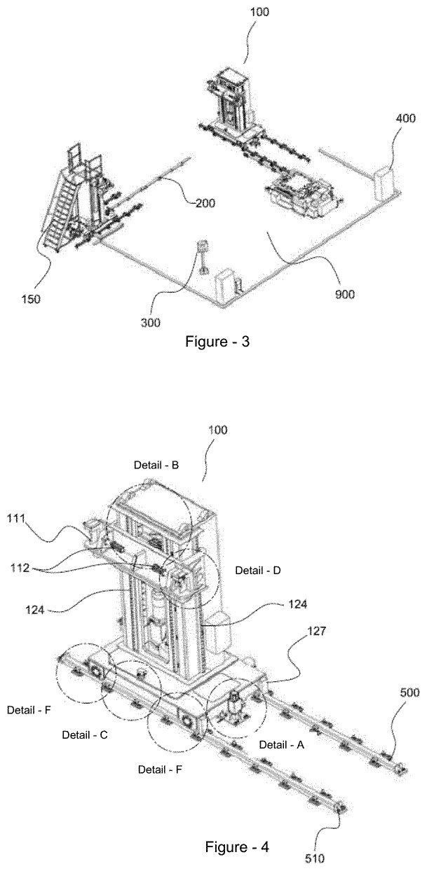

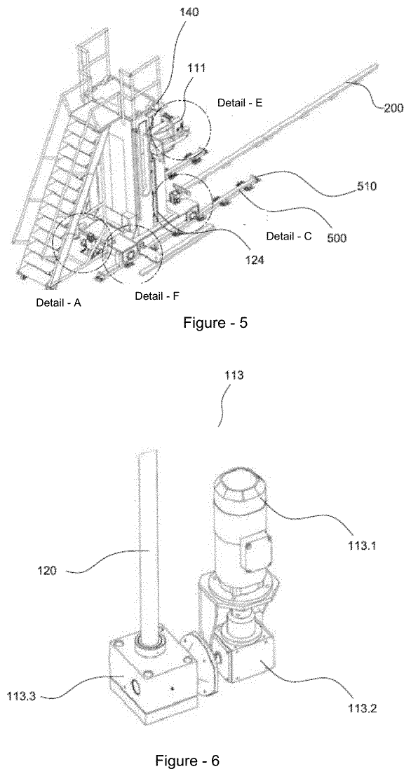

In FIG. 1, FIG. 2 and FIG. 3, the wheeled military land vehicles assembly/disassembly automation system is shown. In FIGS. 4 and 5, the drive (100) and slave (150) towers that are the two main elements of the invention are shown. Both towers (100, 150) also have heavy tonnage capacity and carry the vehicle body (700) configurations (type/variant) safely in accordance with the variable weight centers within the maximum weight limits. The drive tower (100) is the carrier structure that its height can be adjusted on the “Z” axis with the ball screw (120) structure, that has a mobility capability that can move on the “X” axis with the PLC (400) system controlled tower movement system (133) drive on the rail (500) anchored to the ground and that is connected with the mounting apparatus (111) of the military vehicle (700) on which a process is carried out. The slave tower (150) is the carrier structure that its height can be adjusted on the “Z” axis with the ball screw (120) structure, that has a mobility capability that can move on the “Y” axis with the PLC (400) system controlled tower movement system (133) drive on the rail (500) anchored to the ground and that is connected with the mounting apparatus (111) of the military vehicle (700) on which a process is carried out. As a design, the driver tower (100) is not different from the slave tower (150), the difference is formed by the tasks (functions) assigned to the towers (100, 150) by the program. The rail slide (127) having a guiding structure enables the towers (100, 150) to move sensitively on the rail (500) on the X and Y axes. At this place, the tower stopper (510) ensures that the towers (100, 150) stands safely at the rail (500) border point. The protective blower (110) that protects the moving elements on the towers (100, 150) and the automatic guided vehicle (600) from the external factors (dust, water, impact, etc.) and prevents these moving elements from harming the personnel. In the up/down (Z axis) movement of the assembly apparatus (111) and automatic guided vehicle (600), it is adapted by being supplied from the market as standard that is opened/closed with the blower structure and processed according to the system.

The body mounting apparatus (111) has been specially designed to safely fix the military vehicle body (700) to be mounted/disassembled to the towers (100, 150) by using the PLC system (400) controlled main mounting body lock pins (112). Here, there are pin slots/lugs on the mounting body (700) where the pins will locate; the pins (112) provide safely locking by entering these lug slots. The locking takes place not mechanically (without man power) but completely by PLC System (400) controlled (automatic) pneumatic system.

The vertical movement system (113) shown in FIG. 6 provides the up/down (Z axis) movement of the mounting apparatus (111) on the towers (100, 150). Here, the vertical movement motor (113.1) of the PLC system (400) is activated and transmits the rotation movement to the reductor 1 (113.2). Reductor 1 (113.2) is the standard gearing designed to reduce/adjust the high rotation speed from the vertical movement motor (113.1) to the rotation speeds required for the Z axis (up/down) movement of the tower and transfers the rotation movement to the reductor 2 (113.3). Reductor 2 (113.2) transfers the movement to the ball screw (120). The bearing (126) is connected to the towers (100, 150) and supports the up/down (on the Z axis) movement of the mounting apparatus (111) providing the up/down (on the Z axis) movement of the carrier table (123) by rotating around the ball screw (120). The maximum (up) and minimum (down) distance positions of the carrier table (123) on the Z axis are determined by the safety shafts (125) controlled by the PLC system (400). When the carrier table (123) reaches to the position determined on the Z axis, the PLC system (400) ends the vertical movement (down/up) by being activated with its contact with the switches (125).

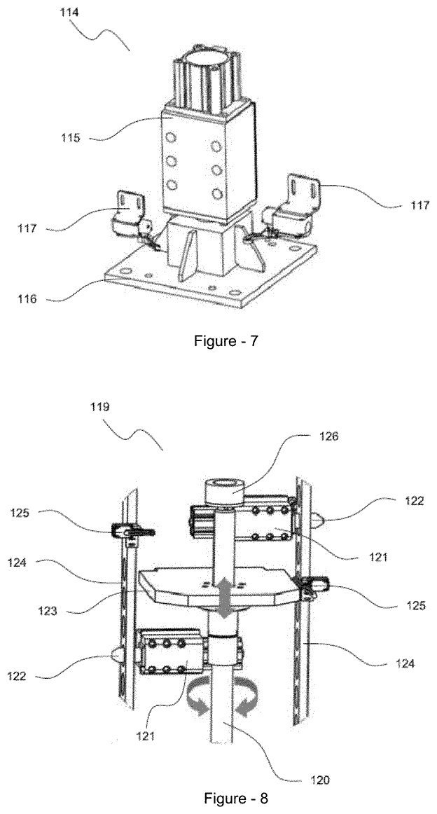

When the towers (100, 150) reach their desired position (on the X and Y axis) on the rail (500), the PLC system (400) provides the ground lock system (114) shown in FIG. 7, to be fixed with a controlled pneumatic drive. It consists of two main elements, the pneumatically driven lock pin (115) and the lock main body (116). The pneumatic driven lock pin (115) is fixed to the tower (100, 150) with the standard connectors and moves together with the tower (100, 150). When the tower (100, 150) reaches its position (on the X and Y axis) on the rail (500), the pneumatically driven lock pin (115) is activated by the control of the PLC system (400) and ensures that the tower fixed to the ground is fixed to the main lock body (116), thus ensuring that the tower (100, 150) stays stable during the operation. The unlocking/locking function is controlled by the PLC system (400). The tower main lock body (116) has been mounted more than once on the ground according to the different vehicle body (700) sizes (variants/types). While the horizontal axis safety switch (117) is fixed to the tower (100, 150) body with the standard connectors and moves on the rail (500), it sends signal to the PLC system (400) by its contact with the lock body (116) preadjusted according to the mounting body (700). The PLC system (400) calculates the distance traveled by the tower (100, 150) according to the number of rotation of the horizontal movement motor (134) and controls whether the tower (100, 150) has reached the predetermined position by checking the coordinates on the horizontal axis (X or Y axis). The PLC system (400) confirms the accuracy of the position with double control by using the data from the safety switch (117), and safely ends the movement of the tower (100, 150) on the horizontal axis (X or Y axis).

The vertical movement lock system (119) shown in FIG. 8 fixes the mounting apparatus (111) to the tower (100, 150). It remains in a locked position continuously during the operation. When the body mounting apparatus (111) is desired to be moved up/down on the Z axis from the PLC system control (400) or the manual control panel (300), the lock bolt (122) is automatically retracted by the control of the PLC system (400) and the mounting apparatus (111) is released. It prevents the tower (100, 150) from leaving the mounting body (700) in case of failure. It consists of two main elements, the lock body (121) and the lock bolt (122). The lock body (121) is the body element of the PLC system (400) controlled safety lock system (119) allowing the lock bolt (122) to enter the lock slots on the vertical rail (124) with its pneumatic drive. By keeping the lock bolt (122) in the closed position continuously during the operation, it is in a structure that prevents uncontrolled release (falling) by fixing the carrier plate (123) connected with the mounting apparatus (111) to the vertical rail (124). It is fixed to the body mounting apparatus (111) with the standard connectors. When the carrier table (123) is desired to be moved up/down on the Z axis from the PLC system control (400) or manual control panel (300), the mounting plate (111) becomes released by retracting the lock bolt (122) automatically with the control of the PLC system (400).

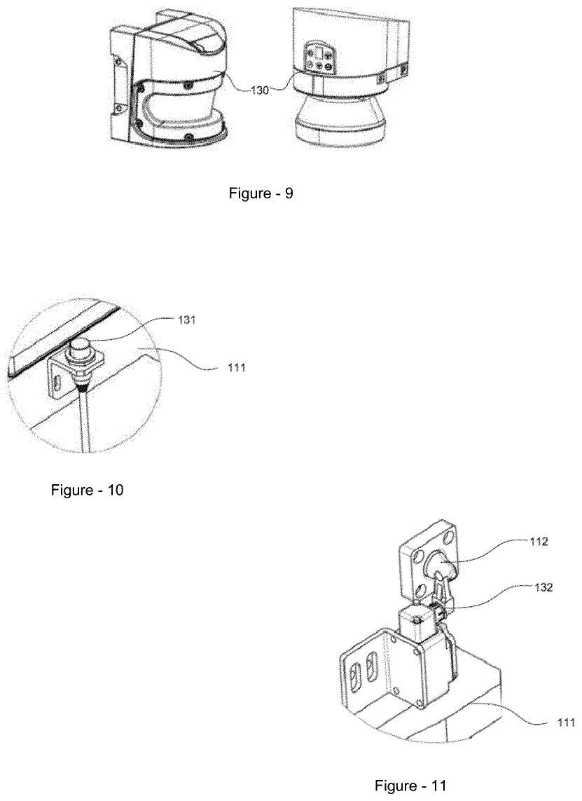

On the tower (100, 150), there is an area scanner sensor (130) mounted with standard connectors and shown in FIG. 9. It is the safety system that automatically ends the system when a situation against the safety (in case of undesired object or human entering the controlled area) occurs within the automation cell (900) with a wide viewing angle and distance perception. It is controlled by the PLC system (400) and provides instantaneous data flow to the system. The existence absence sensor (131) shown in FIG. 10 detects the existence-absence information of the military vehicle body (700) placed on the body mounting apparatus (111) and transfers it to the PLC system control. Therefore, the main mounting body ensures that the lock pins (112) are provided to fix the vehicle body (70) to the mounting apparatus (111). When the lock pin (112), which is under the control of the PLC system (400), is taken to the locking position, it triggers the mounting lock switch (132) shown in FIG. 11 and transmits the information whether the locks are activated or not to the system. If the locking is not activated, the lifting commands of the towers (100, 150) do not work.

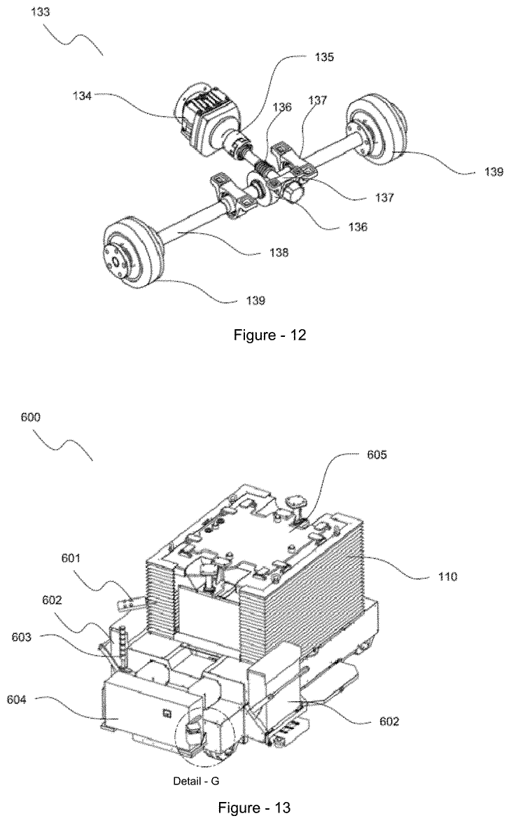

The tower horizontal movement system (133) that allows the drive tower (100) to move to the desired position around the program by moving on the anchor rail (500) on the X axis of the slave tower (150) with the control of the PLC system (400) is shown in FIG. 12. It is a horizontal movement system complex consisting of movable elements such as servo motor (134), coupling (135) gear system (136), bearing (137), wheel shaft (138) and tower wheel (139). The encoder connected to the servo motor (134) shaft sends a signal to the servo drive to continuously control the rotation direction, speed and angle of rotation of the servo and commands the servo motor (134) according to the signals received to the drive and is controlled by the feedback signal.

The PLC (Programmable Logical Controller) system (400) is the central control and management unit that control all moving elements and safety systems within the program limits within the automation system. It has its own database and is programmable. The vehicle body (700) and work piece (800) information (size, weight, mounting points, mounting coordinates, etc.) to be reassembled/disassembled to the PLC system (400) can be predefined via the control panel (300). From the information entered in the database, before the assembly/disassembly, the vehicle body (700) type and work piece (800) type are selected on the control panel (300), and the process steps predefined in the program are performed automatically by the PLC system (400). It is the automation system that provides all the inspection and control of the tower systems (100, 150) and automatically guided device (600). All movements within the automation cell (900) are automatically inspected and controlled by PLC system (400). It has a wireless communication infrastructure. All the sensors and switches on the system provide data flow to the PLC system control (400), and by this data, the positions of the towers (100, 150) and automatically guided vehicle (600) (on the X, Y and Z axes), all safety pins and warning system are controlled. Also, the PLC system control (400) unit instantly transmits the information about the status of the system within the mounting cell (900) from the screen on the control panel (300) by evaluating the data received from the sensors and switches. By controlling the system and safety limits (area information, carrying capacity, vehicle and subsystem information) predetermined to the PLC system (400) control as the real time by the logical controller, when a situation against to the work safety occurs, the system has the infrastructure to end the operation steps in a controlled and safe manner by performing audible and visual warnings via the warning system (140, 603) and via the screen (300). The information recorded in the database of the PLC system (400) has a flexible structure that can be changed, updated, added and removed at any time by means of the user interface and it can be improved.

In FIGS. 13, 15 and 17, the automatically guided vehicle (600) of the wheeled military vehicles assembly/disassembly automation system is shown. This is a moving platform structure which has heavy tonnage capacity and has the movement ability on X, Y and Z axes on which the work piece (800) to be mounted is positioned, and, which is controllable except PLC system (600) control (program) on every axis (X, Y and Z) wirelessly by means of remote control panel (300) or manually by means of the vehicle controller (601) on it and has a chargeable wireless power supply (traction battery) (602). There is an emergency stop button on the vehicle control (601) as a safety system. The vehicle consists of 5 main components: PLC system (604), upper plate complex (605), scissor platform complex (608), upper car complex (609) and lower car complex (610). All movements are controlled automatically by the PLC system (604) on it and it exchanges data in connection with the main PLC system (400). It is the automation system that provides all the inspection and control of the automatically guided vehicle (600) and controls its movements in all directions (on the X, Y and Z axis). There is an emergency stop button (607) that is used for the safe manual stop of the automatically guided vehicle (600) when an unsafe situation occurs during the operation. The sensors and switches on the vehicle (600) process the data that they receive and work synchronously with the main PLC system control (400) and provide real-time wireless data flow to each other. There is a warning system (140, 603) mounted on the tower (100, 150) and automatically guided vehicle (600) to form a safe working environment and informing the operator whether the system is working/not working or if there is/is not an unsafe condition in different sounds and colours (yellow, red and green).

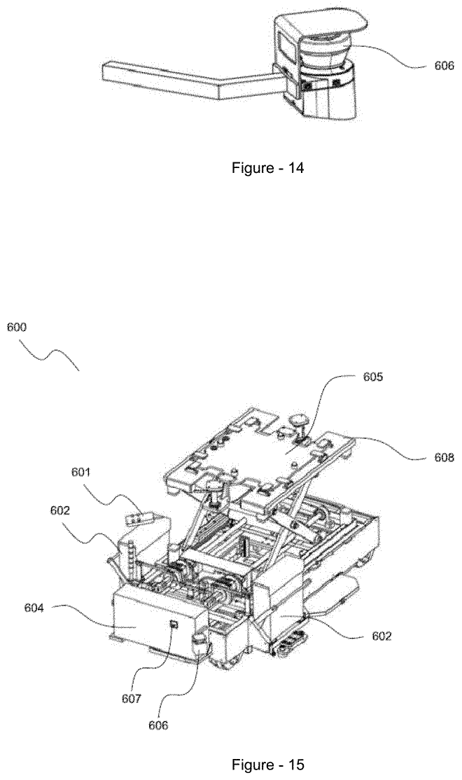

In FIG. 14, the scanner sensor (606) of the automatically guided vehicle (600) is shown. These are the 2 area scanning sensors that are assembled on the cross corners of the vehicle (6). It is the safety system that automatically stops the system when the vehicle (600) moves against the safety in the movement area (entry of an undesired object or human to the controlled area) with its wide viewing angle and distance perception. The vehicle is controlled by the PLC system (604) and provides instantaneous data flow to the system.

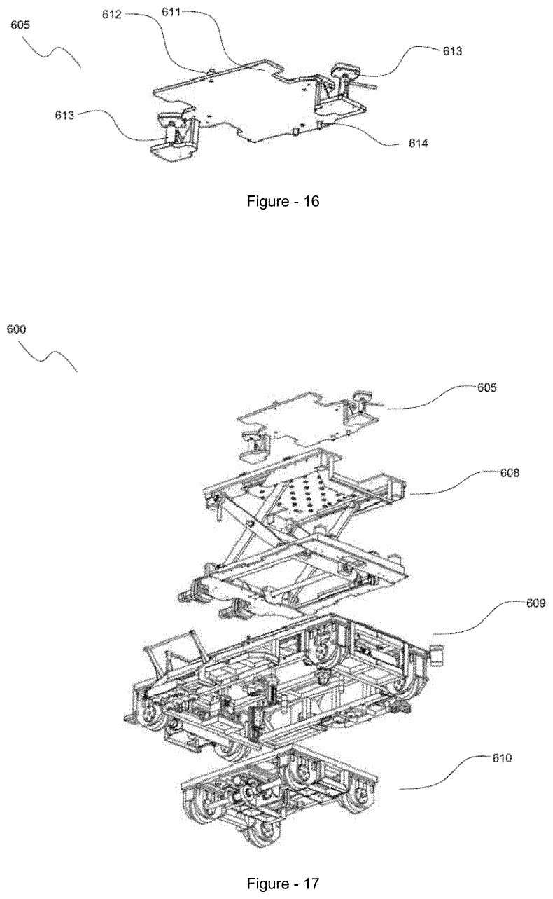

In FIG. 16, the upper plate complex (605) of the automatically guided vehicle (600) is shown. It is a structure complex specially designed for the work piece to which the work piece (800) to be mounted is connected. It is integrated into the system with the simple mechanical changes according to the work piece (800) type/variants. The carrier plate (611) carrying the work piece (800) is a structure that slides/travels on the scissor platform complex (608) with the help of balls (615). The work piece (800) is fixed on the carrier plate (611) with the positioning pins (612). The hydraulic jack (613) allows the operator, if necessary, to position any structure of the sub-system in relation to the Z axis, on the carrier plate (611) according to the type of work piece (800) to be assembled -/disassembled (for example, it is used for lifting/aligning axle arms to the mounting slots in the axle assembly.) The centering pin (614) is used to center the carrier plate (611) finely tuned to the scissor platform upper table (616).

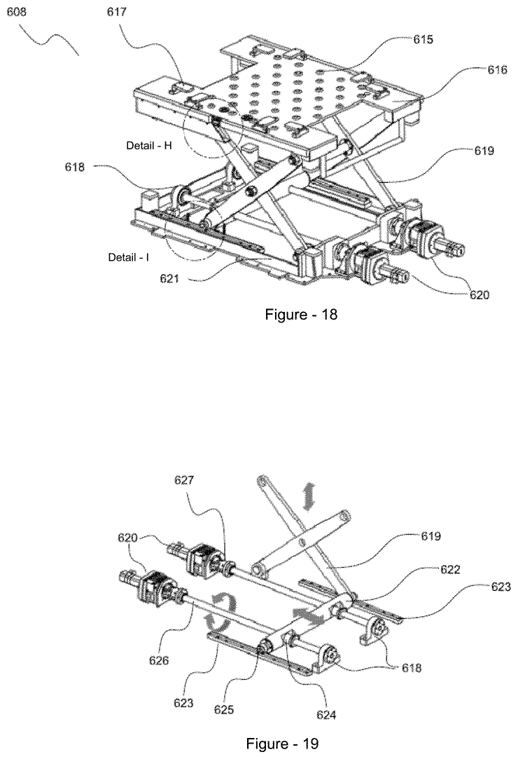

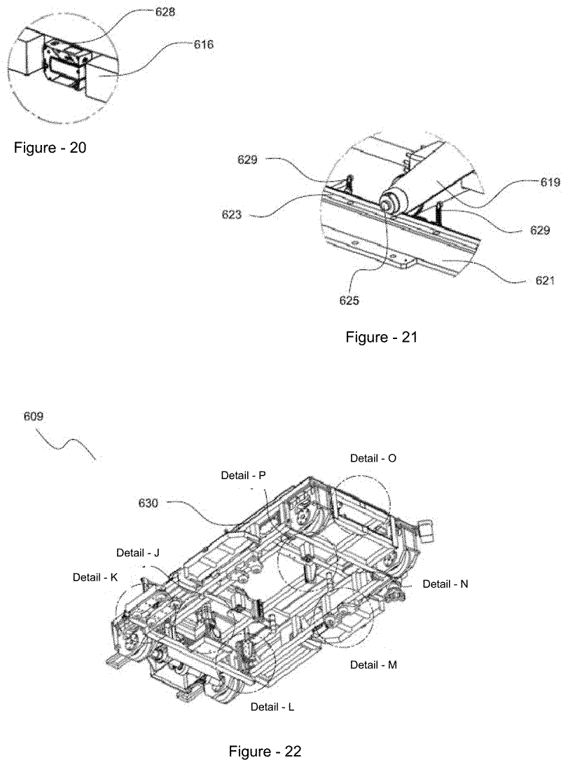

In FIGS. 18, 19, 20, 21, the scissor platform complex (608) and details of the automatically guided vehicle (600) are shown. The scissor platform complex (608) provides the movement of the automatically guided vehicle (600) on the Z axis. Here, the balls (615) allow the upper plate complex (605) to move easily on the scissor platform upper table (616) (providing sliding travel). It provides comfortable positioning of the work piece (800) on the vehicle (600). The fixing apparatus (617) fixes the upper plate complex (605) on the scissor platform upper table (616) in a way that limits it from the edges. During the operation of the plate (605), it prevents sliding on the balls. It is not completely fixed, the plate (605) is limited by these apparatus (617) from the edges, it can move in the direction of the limits. It is a high tonnage scissor structure (619) that opens and closes with the drive taken from the motor (620) and enables the scissor platform upper table (616) to move up/down on the Z axis. While one end of the structure is fixed to the scissor platform lower table (621) with a screwed pin structure, the other end is connected to the puller shaft (622). With the command received from the vehicle PLC (604) system, the servo motor (620) activates and mobilizes the ball screw (626) through the coupling (627). In order to provide that the platform (608) moves on the Z axis in a balanced way, double motor (620) working synchronously with each other was used. (The encoder connected to the servo motor (620) shaft (626) sends a signal to the servo drive and continuously commands the servo motor (620) according to the incoming signals and is controlled by the feedback signal.) Puller shaft (622) is the structure that moves forward/backward with the drive it receives from the ball screw (626) and the ends of the scissor structure (619) are fixed. It is a shaft structure that moves sensitively forward/backward on the scissor rail (613) connected to the bottom table (621) with the bearings (625) attached to its ends. Here, the ball screw bearing (618) ensures that the ball screw (626) rotates sensitively around its axis. The puller slot (624) with the gear bearing structure is fixed to the puller shaft (622) by welding or standard connectors and turns the rotating movement of the ball screw (626) into the horizontal movement for the puller shaft (622) on which it is mounted. While the distance sensor (628) moves on the Z axis of the automatically guided vehicle (600), it enables to the lifting/lowering movement to be ended automatically with the PLC system (604) control when it reaches to the Z position defined for the PLC system (400) by measuring the distance to the work piece (800) connected to the towers (100,150). The stop switches (629) are the standard safety switches that determine the maximum and minimum lifting points on the Z axis of the automatically guided vehicle (600), and send a signal to the vehicle PLC system (604) with the drive of the puller shaft (60) to end the movement.

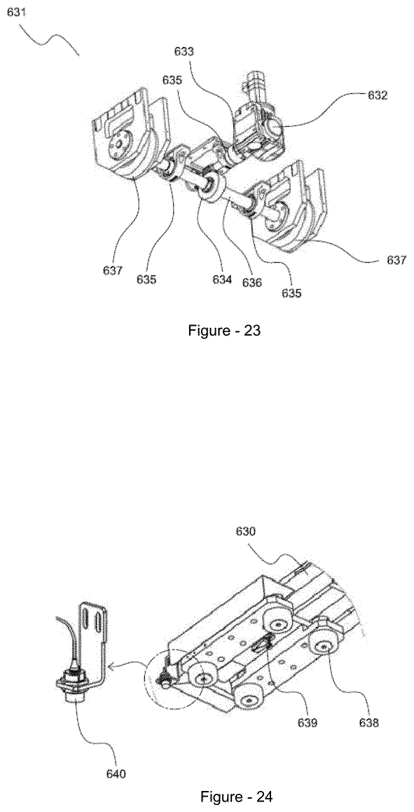

In FIG. 22, the upper car complex (609) of the automatically guided vehicle (600) and its details are shown. The upper car complex (609) provides the movement of the automatically guided vehicle (600) on the X axis. In FIG. 23, the upper car movement system (631) is shown. The upper car movement system (631) moves the automatically guided the vehicle (600) on the X axis in the assembly cell (900) with the control of the PLC system (400), so that it reaches the desired position within the framework of the program. Here, the servo motor (632) is activated by the command received from the vehicle PLC system (604) and transmits the rotational movement to the gear system (634) via the coupling (633). The gear system (634) also transmits the rotational movement to the upper car wheels (637) via the wheel shaft (636) supported by the bearing (635). The heavy tonnage capacity upper car wheels (637) move the automatically guided vehicle (600) forward/backward along the X axis within the assembly cell (900) with the rotational movement it receives and allow it to reach the desired position within the framework of the program. Here, the encoder connected to the servo motor (632) sends a signal to the servo drive to control the rotation direction, speed and angle of rotation direction of the servo and commands the servo motor (632) according to the signals received to the drive and is controlled by the feedback signal.

In FIG. 24, the track rail slide of the automatically guided vehicle (600) is shown. Here, there are track rail bearings (X axis) (638) on the track rail (200), which enables the automatically guided vehicle (600) to move sensitively on the X axis. The automatically guided vehicle (600) automatically finds the rail (2000) with the help of the PLC system (604) controlled sensor (640) and is programmed by moving on the X axis of the automatically guided vehicle (600) by sliding on the rail (200) with the help of the bearings (638) and it is the structure design that enables it to come to the programmed position. The automatically guided vehicle (600) normally does not need this structure within the automation cell (900). The vehicle (600) can be self-guiding; its use is optional according to the ground structure on which it will operate. Also, the limit switch (639) sends a signal to the PLC system (400) control when the automatically guided vehicle (600) reaches to the starting point (home) on the X axis on the track rail (200). It sends the information that the vehicle (600) is at the starting point to the PLC system (400) and ensures that the operation ends safely.

In FIG. 25, the rail car mechanisms (641) of the automatically guided vehicle (600) are shown. Here, the rail car mechanisms (641) provide the flexibility between the upper car complex (609) and the lower car complex (610) and the sensitive up/down movement of the upper car (609) with the hydraulic cylinders (647) on the lower car (610).

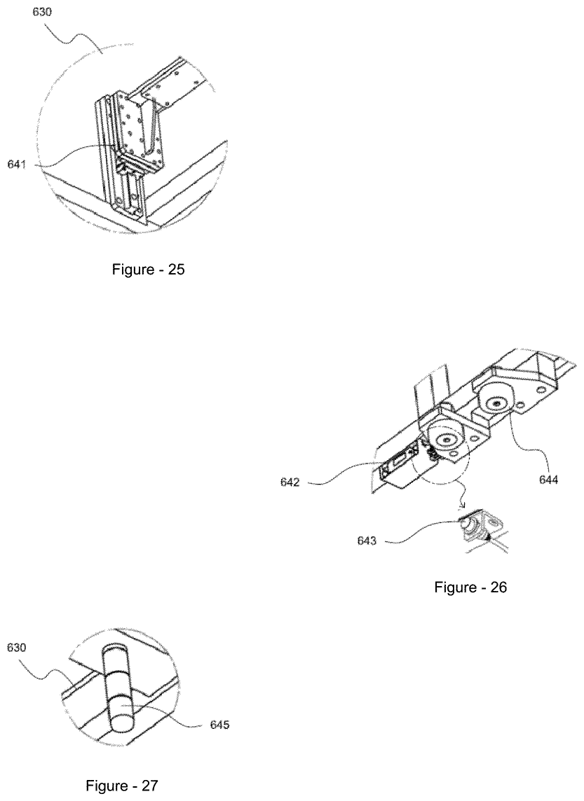

In FIG. 26, the upper car (609) Y axis track rail slide of the automatically guided vehicle (600) is shown. Here, while the distance sensor (642) moves in the Y direction on the track rail (200) of the automatically guided vehicle, it provides to automatically end its movement with the vehicle PLC system (604) control when it reaches to the position defined to the PLC system (400) by measuring the distance with the slave tower (150). The vehicle PLC (604) system calculates whether the vehicle (600) is in the programmed position on the Y axis according to the rotation number of the horizontal movement motor (652) on the lower car movement system (651). The vehicle PLC system (604) confirms the accuracy of the position with double control by using the data from the distance sensor (642) and safely ends the movement of the vehicle (600) on the Y axis. On the other hand, the limit sensor (643) detects the mechanical part at the end point of the automatically guided vehicle (600) on the track rail (200) and sends the information that the vehicle (600) exceeds the specified position to the vehicle PLC (604) system and ensures that the vehicle (600) stops automatically. The track Rail bearings (644) (Y axis) provides the automatically guided vehicle (600) on the track rail (200) to move sensitively on the Y axis.

In FIG. 27, the upper car centering pins (645) of the automatically guided vehicle (600) are shown. These pins (645) are used to center the upper car complex (609) to the lower car complex (610). The pins (645) run within the centering columns (649) on the lower car (610).

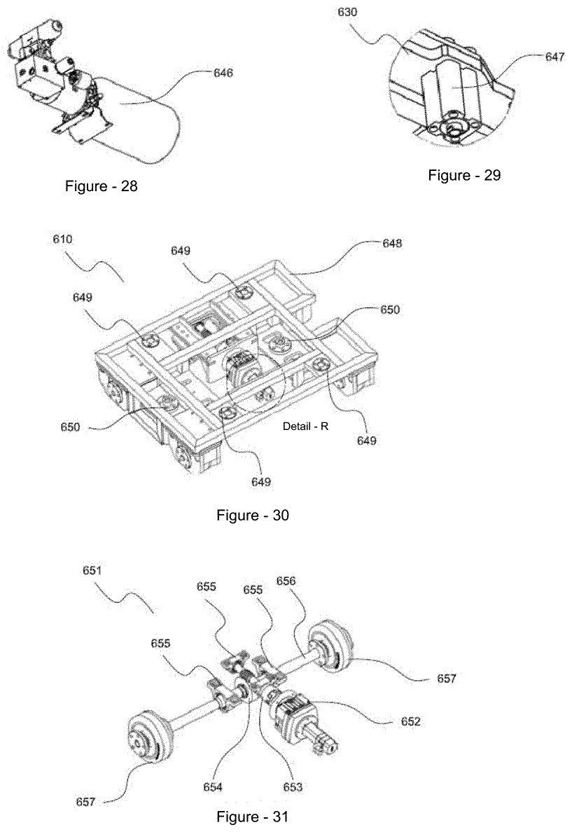

In FIGS. 28 and 29, the hydraulic unit (646) and hydraulic cylinders (647) of the automatically guided vehicle (600) are shown. The hydraulic cylinders (647) cut the contact of the upper car (609) with the ground by applying power to the pressure plates (650) on the lower car (610) with the drive it receives from the hydraulic unit (646). Therefore, the lower car (650) contacts the ground and the automatically guided vehicle (600) is enabled to move on the Y axis. Briefly, it enables the upper car (609) on the vehicle (600) to move up and down on the lower car (610). There are two units on the vehicle (600); the system operating with the control of the vehicle PLC system (604) enables the upper car (610) to be lifted/lowered in a balanced way.

In FIG. 30, the lower car complex (610) of the automatically guided vehicle (600) is shown. Here, all the elements forming the lower car complex (610) are mounted on the lower car body (648) and have the capacity of carrying the high tonnage work piece (800).

In FIG. 31, the lower car movement system (Y axis) (651) of the automatically guided vehicle (600) is shown. The lower car movement system (651) enables the automatically guided vehicle (600) to reaches the desired position in the frame of program by moving it on the Y axis within the mounting cell (900) with the PLC system (400) control. Here, the servo motor (652) activates with the command it receives from the vehicle PLC system (604) and transfers the rotation movement to the gear system (654) through the coupling (653). The gear system (654) also transmits the rotation movement to the lower car wheels (657) through the wheel shaft (656) supported by the bearing (655). The heavy tonnage capacity lower car wheels (657) move the automatically guided vehicle (600) forward/backward along the Y axis within the mounting cell (900) with the rotational movement it receives and enables to reach the desired position within the framework of the program. Here, the encoder connected to the servo motor (652) shaft sends a signal to the servo drive to control the rotation direction, speed and angle of rotation direction of the servo and commands the servo motor (652) according to the signals received to the drive and is controlled by the feedback signal.

The working principle (operation steps) of the assembly/disassembly automation system is as follows:

The technical information (size, weight, mounting points, working height, mounting coordinates, etc.) of the main body (700) and work piece (800) to be processed on the database of PLC (400) system are predefined to the system on the control panel (300). These data are stored in the database for the later use.

The operator selects the type of vehicle body (700) and subsystem (800) (axle complex type, suspension type, power group type, etc.) to be processed (assembly/disassembly) on the control panel (300) that has been predefined to the system.

The PLC system (400) activates the tower movement systems (133) and automatically brings the towers (100, 150) to the most suitable position on the rail (500) for the body (700) mounting on the X and Y axis. This process can also be performed manually by the operator by selecting the tower manual mode on the control panel (300) and using the direction buttons on the screen.

Safety system: The tower (100, 150) moved on the rail (500) apart from the program stops safely based on the tower stopper (510) when the rail (500) reaches the border point.

In both methods, when the vehicle body (700) reaches the programmed position, the safety switches (117) send a signal to the PLC system (400) and the tower ground lock system (114) automatically positions the towers (100, 150) by fixing them.

Safety system: The movements given from the control panel (300) while the towers (100,150) are being adjusted according to the type/variant (measures) are limited with the switches (117). The tower ground lock system (114) will not be activated before the switches (117) are activated. In addition, the vehicle body (700) cannot be connected to the towers (100, 150) and the tower vertical movement system (113) cannot be commanded without the drive (100) and the slave tower (150) ground locking system (114) being activated.

Simultaneously with the activation of the ground locking system (114), the vertical movement system (113) of the tower activates and brings the mounting body apparatus (111) to the most appropriate position on the Z axis where the vehicle body (700) can be connected according to the operator. In this process, if desired by the operator, the manual mode can be selected on the control panel (300) and manually by using the direction buttons on the screen.

The vehicle body (700) is placed on the mounting apparatus (111) on the towers (100, 150). When the existence/absence sensor (131) detects the vehicle body (700), the PLC system (400) controlled main mounting body lock pins (112) automatically become active and fix the vehicle body (700) to the mounting apparatus (111). During the locking, the lock pins (112) trigger the lock switch (132) and transmit the information whether the locks are activated or not to the PLC (400) system.

Safety system: When the vehicle body (700) is placed on the towers (100,150), the main body lock pins (112) do not work if the existence/absence sensors (131) do not become active. In addition, the towers (100, 150) cannot be moved until the safety switches (132) are activated, that is, the locking process is performed safely.

Before the locking is performed safely, the vehicle body (700) is automatically brought to the pre-programmed assembly/disassembly height with the vertical movement system (113) triggered by the PLC system (400) for the assembly of the subsystem (800).

Safety system: The safety lock system (123) is in a continuously locked position to keep the mounting apparatus (111) fixed to the tower during the operation. When the body mounting apparatus (111) is desired to be moved up/down on the Z axis from the PLC system (400) or the manual control panel (300), with the control of the PLC (400) system, the lock bolt (122) is automatically retracted and the mounting table (111) becomes free. It prevents the tower (100, 150) from leaving (falling) the mounting body (700) in case of failure.

This process can be performed manually by selecting the manual mode on the control panel (300) if desired by the operator and using the directional keys on the screen. However, in manual use, while being lifted with the servo movement (113), the synchronous lifting mode (both towers at the same time) should be selected, since the vehicle body is fixed on the towers (100, 150); asynchronous movement of the system towers (100, 150) is not allowed. When the vehicle body (700) reaches the desired position manually, the vertical movement lock system (119) is activated on the control panel (300) upon the instruction of the operator.

Safety system: For the optimum mounting height (on Z Axis) that the automatically guided vehicle (600) should be activated, the process continues until the “Height Sufficient” tab turns from red to green on the screen. Otherwise, the automatically guided vehicle (600) movement will not start.

When the lockings become active, the area scanning sensors (130) on the towers (100, 150) are automatically activated.

Safety system: The minimum and maximum movement of the mounting apparatus (111) on the towers (100, 150) on the Z axis are limited by the vertical movement safety switches (125). Also, the automatically guided vehicle (600) cannot be activated before the vehicle body (700) on the towers (100, 150) reaches a sufficient height for the assembly/disassembly.

When the vehicle body (700) is brought to the height programmed for the safe assembly/disassembly, the automatically guided vehicle (600) at the home (zero/start) point is automatically activated by the control of the vehicle PLC system (604). According to the type of work piece (800) to be mounted on the vehicle body (700), it automatically adjusts itself to the optimum height on the Z axis where the work piece (800) will be loaded on the vehicle (600). This process can also be performed manually with the control handle (601) on the vehicle (600).

While the automatic guided vehicle (600) is in the home (zero/start) position, the subsystem (800) to be assembled is placed on the upper plate complex (605) by centering it with the help of work piece positioning pins (612).

Safety system: The work piece (800) cannot be incorrectly placed on the top plate complex (605); the work piece positioning pins (612) will prevent this.

According to the type of work piece (800) to be assembled/disassembled, there is a manual jack system on the carrier plate (611) that enables the operator to position any structure of the subsystem according to the Z axis if necessary. (For example: In the axle complex assembly; it is used to lift/align the axle arms to the mounting slots.) There is no obligation to use.

With another method, the work piece (800) previously placed on the upper plate complex (605) is easily shifted onto the scissor platform complex (608) with the help of balls (615) and the upper plate centering pins (614) are placed on the platform (616) and fixed on the automatically guided vehicle (600) with the plate fixing apparatus (617).

Safety system: While the automatically guided vehicle (600) is in the home (zero/start) position, the operator controls that the upper plate centering pins (614) on the work piece carrier plate (611) are securely seated on the scissor platform complex (47), these pins (614) ensures that the work piece carrier plate (611) is in the fixed position.

The operator makes the process selection (these selection modes have been predefined to the system), where the X, Y and Z position (coordinate) record is located, through which the work piece (800) will be guided through the control panel (300).

By activating the upper car movement system (X Axis) (631) on the upper car complex (609) with the vehicle PLC control (604), it automatically enables the automatically guided vehicle (600) to reach to the X coordinate predetermined in the program with the subsystem (800).

The vehicle (600), which reaches the position determined in the X coordinate, again activates the hydraulic unit (646) of the vehicle PLC system (604) and applies a 60 mm stroke to the lower car complex (610) of the hydraulic cylinders (610) on the Z axis and cuts the contact of the upper car complex (609) with the ground. When the contact of the upper car complex (609) with the ground cuts, the vehicle (600) becomes movable on the Y axis on the lower car complex (610). This time, by activating the lower car movement system (Y Axis) (651) on the lower car complex (610) with the control of the PLC system (604), it automatically ensures that the automatically guided vehicle (600) reaches to the Y coordinate predetermined in the program together with the subsystem (800).

The movement of the automatically guided vehicle (600) on the X and Y axis can also be performed manually by using the vehicle control (601) if desired by the operator.

Safety system: The automatically guided vehicle (600) cannot collide with any obstacles that may appear in its way, when the area scanner sensors (606) encounter the obstacle; the PLC system (604) becomes active and ends the movement of the vehicle (600).

Immediately after the automatically guided vehicle (600) is positioned at the X and Y coordinates, simultaneously the PLC system control (604) activates the scissor structure movement motor (620) and the scissor movement starts automatically. The work piece (800) continues the Z movement on the scissor platform complex (608) and stops when it reaches the preadjusted final position.

Safety system: Automatically guided vehicle (600) cannot move the subsystem (800) to a position different from the position selected from the control panel, as required by the program. The encoders connected to the scissor structure movement motor (620), horizontal movement motors (X Axis) (632) and (Y Axis) (652) send the motor rotation direction, speed and rotation angle information to the vehicle PLC system (604) system in real time. The vehicle PLC system (604) processes this data and makes the necessary adjustments automatically.

Movement of the automatically guided vehicle (600) on the Z axis can also be performed manually by using the vehicle control (601) if desired by the operator.

Safety system: The vehicle PLC system (604) confirms the distance sensor (Z Axis) (628) that sees the main mounting body (700) on the tower (100, 150) where the lifting work will be on the Z axis.

When the automatically guided vehicle (600) reaches the position programmed on the Z axis, it takes its final position for the work piece (800) assembly. The operator reaches the step on the vehicle (600) to complete the assembly of the subsystem (800) ergonomically and completes the assembly operation by fixing the work piece (800) to the main vehicle body (700) using the connection bolts for the final assembly.

It commands the automatically guided vehicle (600) to go to its home position by the operator via the control panel (300) or via the vehicle control (604). The automatically guided vehicle (600) goes to the zero (home) point by applying the steps it performs on the Z, Y and Z axes for the assembly with the control of the vehicle PLC (604) system in reverse and takes the position for the second work piece (800) assembly.

Safety system: Automatically guided vehicle (600) ensures that it returns to its home position after the operation with the servo motors (620, 632 and 652), the limit switch (700) and the limit sensor Again safety system: When a situation against the work safety occurs during the manual or automatic operation, the system can be stopped safely by using the emergency stop buttons on the PLC system (400), the control panel (300) and the vehicle PLC system (604).

The PLC system (400) control provides a continuous flow of the data from the sensors and switches, and automatically informs the operator about the status of the system in all operation steps in an audio and video way. When an unsafe situation occurs, it automatically stops the system safely.

The scope of protection of this application is determined in the claims, and it is obvious that a person skilled in the art can set forth the innovation presented in the invention by using the similar configurations and/or apply this structure to other similar fields used in the related technique. Thus, it is apparent that such structures will be lack of exceeding the criteria of the innovation and especially the state of the art.

1. Automatic assembly/disassembly of the vehicle subsystems such as wheel, suspension, axle complex, power transfer centering control and management unit, characterized in that; it comprises at least one PLC system (400) that:
controls all moving elements and safety systems within the automation cell (900) within the program limits;
the vehicle body (700) and work piece (800) information (size, weight, mounting points, mounting coordinates, etc.) to be assembled/disassembled are predefined;
processes the data instantaneously and automatically performs the process steps predefined in the program by selecting the vehicle body (700) type and work piece (800) type on the control panel (300) before assembly/disassembly from the information entered in the database;
has the substructure of wireless communication;
instantly transmits the information about the status of the system in the mounting cell (900) to the operator from the display on the control panel (300) by evaluating the data received from the sensors and switches; and
stops the process steps in a controlled and safe manner with audio and video stimulus through the warning system (140, 603) and screen (300); wherein the system enables that the predefined system and safety limits (area information, carrying capacity, vehicle and subsystem information) are controlled real-time by the logical controller, when a situation is experienced against work safety.

2. Automatic assembly/disassembly of the vehicle subsystems such as wheel, suspension, axle complex, power transfer centering control and management unit, characterized in that; it comprises the vehicle PLC system (604) that provides all the inspection and control of the automatically guided vehicle (600), controls its movements in all directions (X, Y and Z axis), and exchanges data in connection with the main PLC system (400).

3. PLC system (400) according to claim 1, characterized in that; it brings the towers (100, 150) to the suitable position for the movement system (133) vehicle assembly/disassembly on the rail (500) anchored to the ground.

4. PLC system (400) according to claim 1, characterized in that; the military vehicle body (700) to be assembled/disassembled is securely fixed to the towers (100, 150) by moving the lock pins (112) pneumatically and inserting them into the slots on the vehicle body (700).

5. PLC system (400) according to claim 1, characterized in that; it moves the carrier table (123) in a vertical manner (up/down) which supports the up/down movement (in Z axis) of the mounting apparatus (111) wherein the mounting of the vehicle body (700) is performed by giving command to the vertical movement motor (113.1) and the carrier table (123) terminates the vertical movement (up/down) with its contact with the switch (125) by reaching to the position defined in Z axis.

6. PLC system (400) according to claim 1, characterized in that; it fixes the towers (100,150) to the ground pneumatically by commanding the ground lock system (114) when they reach the desired position on the rail (500) (on the X and Y axis).

7. PLC system (400) according to claim 1, characterized in that; the motion motor (134) calculates the distance traveled by the tower (100, 150) by counting steps according to the number of rotations and controls whether the tower (100, 150) reaches the predetermined position by checking the coordinates on the horizontal axis (X or Y axis).

8. PLC system (400) according to claim 1, characterized in that; it verifies the accuracy of the position of the tower (100, 150) by using the data from the safety switch (117) and safely ends the horizontal movement of the tower (100, 150) on the X or Y axis.

9. PLC system (400) according to claim 1, characterized in that; it fixes the mounting apparatus (111) connected to the carrier table (123) by enabling the lock bolt (122) to enter the lock slots on the vertical rail (124) by commanding during the assembly/disassembly and removes the lock bolt (122) from the lock slots on the vertical rail (124) by commanding when the assembly/disassembly is over and release the mounting apparatus (111).

10. The PLC system (400) according to claim 1, characterized in that; it comprises the area scanning sensor (130), which stops the system automatically when a situation against the safety (entry of an undesired object or human to the controlled area) occurs within the automation cell (900) with the large viewing angle and distance perception.

11. PLC system (400) according to claim 1, characterized in that; it comprises the existence absence sensor (131), which detects the existence-absence information of the military vehicle body (700) placed on the body mounting apparatus (111) and transfers it to the control of the PLC system (400).

12. Vehicle PLC system (604) according to claim 1, characterized in that; it comprises the area scanning sensor (606), which ends the system automatically when a situation against the safety (entry of an undesired object or human to the controlled area) occurs in the movement area of the vehicle (600) during the operation with the large viewing angle and distance perception, and which is controlled by the vehicle PLC system (604) and provides instant data flow to the system.

13. Vehicle PLC system (604) according to claim 1, characterized in that; it provides the movement of the scissor platform complex (608) of the automatically guided vehicle (600) on the Z axis by activating the ball screw (626) with the command to the servo motor (620) and by the ends of the scissor structure (619) getting closer and further away.

14. Vehicle PLC system (604) according to claim 1, characterized in that; it comprises the distance sensor (628) ending the lifting/lowering movement automatically with the PLC system (604) control when the automatically guided vehicle (600) reaches the Z position defined to the PLC system (400) by measuring the distance to the mounting body (700) connected to the towers (100, 150) while it moves on the X axis.

15. Vehicle PLC system (604) according to claim 1, characterized in that; it comprises stopping switches (629) that determine the maximum and minimum lifting points on the Z axis of the automatically guided vehicle (600), and send a signal to the vehicle PLC system (604) with the drive of the puller shaft (622).

16. Vehicle PLC system (604) according to claim 2, characterized in that; it commands the upper car movement system (631) to move the automatically guided vehicle (600) on the X axis within the mounting cell (900) to reach the desired position within the framework of the program.

17. Vehicle PLC system (604) according to claim 2, characterized in that; the automatically guided vehicle (600) comprises a controlled sensor (640) that enables the vehicle to automatically find the rail (200).

18. Vehicle PLC system (604) according to claim 2, characterized in that; it comprises the distance sensor (642) ending the lifting/lowering movement automatically with the PLC system (604) control when the automatically guided vehicle (600) reaches the position defined in the PLC system (400) by measuring the distance to the slave tower (150) while it moves on the track rail (200) in the Y direction.

19. Vehicle PLC system (604) according to claim 2, characterized in that; the automatically guided vehicle (600) comprises the limit sensor (643) that detects the mechanical part at the end point on the track rail (200) and sends the information that the vehicle (600) exceeds the specified position to the vehicle PLC (604) system and enables the vehicle (600) to be stopped automatically.

20. Vehicle PLC system (604) according to claim 2, characterized in that; it enables the upper car (609) to move on the vehicle (600) up and down on the lower car (610) by commanding the hydraulic unit (646) and the cylinders (647).

21. Vehicle (604) and PLC system (400) according to claim 2, characterized in that; it enables the automatically guided vehicle (600) to move on the Y axis within the mounting cell (900) to the desired position within the framework of the program.
